(19) United States
(12) Patent Application Publication
(10) Pub. No.: US 2004/0205675 A1
(43) Pub. Date: Oct. 14, 2004

(54) System and method for determining a document language and refining the character set encoding based on the document language

(76) Inventors: Thangaraj Veerappan, Cambridge, MA (US); Brendan Murray, Monasterboice (IE)

Correspondence Address: MINTZ LEVIN COHN FERRIS GLOVSKY AND POPEO PC, 12010 SUNSET HILLS ROAD, SUITE 900, RESTON, VA, 20190, US

(21) Appl. No.: 10/042,192

(22) Filed: Jan. 11, 2002

(51) Int. Cl. G06F 17/24

(52) U.S. Cl. 715/536; 715/530

(57) ABSTRACT

A system, method, and processor readable medium for determining a language in which a document is created. After receiving an electronic document, an appropriate character set encoding (or encodings) for the text of the electronic document is determined. The character set encoding(s) indicate a list of potential languages in which the electronic document is created. The potential languages may be identified using bit flags. The number of potential languages for which an electronic document is created may be increased or decreased according to predetermined criteria. The number of potential languages may be adjusted by comparing groups of characters (n-grams) included in the electronic document with entries in a look-up table. If n-grams are located in the look-up table, bit flags associated with the n-grams may be logically ANDed together. This process may be repeated until only a single bit flag remains. The remaining bit flag identifies the language in which the electronic document is created.

### RELATED APPLICATIONS

This application is related to co-pending U.S. patent application Ser. Nos. 09/384,443, 09/384,371, 09/384,442, 09/384,088, 09/384,542, 09/384,541, 09/384,089, and 09/384,538, titled “System and Method For Evaluating Character Sets,” “System and Method for Evaluating Character Sets to Determine a Best Match Encoding a Message,” “System and Method For Evaluating Character Sets Of A Message Containing A Plurality Of Character Sets,” “System and Method For Evaluating Character Sets To Generate A Search Index,” “System and Method For Outputting Character Sets In Best Available Fonts,” “System and Method For Using Character Set Matching To Enhance Print Quality,” “System and Method For Output Of Multipart Documents,” and “System and Method For Highlighting Of MultiFont Documents,” respectively, each filed Aug. 27, 1999, and incorporated herein by reference.

### FIELD OF THE INVENTION

The invention relates to a system and method for determining a language in which an electronic document is created. The system and method use a character set encoding determination to reduce a number of languages to be searched for determining the language in which the electronic document is created.

### BACKGROUND OF THE INVENTION

With the use of the Internet, electronic mail, and related electronic services, communications software has been increasingly called upon to handle data in a variety of formats. While the barriers to simple communications have been removed from many hardware implementations, the problem of operating system or application software being unable to display text in different languages remains.

For instance, a person browsing the World Wide Web may wish to input a search string in their native language which may be a language other than English. Some Web pages or search engines will simply accept that string in the form in which it was input, but not process the spelling, syntax or character set in the native language. The search engine then performs a search as though the search was input in English. This may result in no hits being returned. Other Web pages may allow a user to manually specify a desired language for browsing and searching.

Typical search and index technologies require that the language of a document be identified to enable correct results from a search or look-up. Ambiguity between common words may yield inappropriate results for a particular query. For example, the word “gift” has a different meaning in English than the word “gift” in Scandinavian languages. Existing language identification methodologies are slow and cumbersome. Systems providing such methodologies typically require large databases.

These and other drawbacks exist.

### SUMMARY OF THE INVENTION

An object of the invention is to overcome these and other drawbacks.

Another object of the invention is to provide a system and method that identifies a language in which an electronic document is created.

Another object of the invention is to provide a system and method that use a character set encoding determination to determine a language in which an electronic document is created.

Another object of the invention is to provide a system and method that uses groups of characters in the electronic document to determine a language in which an electronic document is created.

Another object of the invention is to provide a system and method that uses a language determination to refine a character set encoding determination.

The invention overcoming these and other drawbacks is a system and method that determine a language in which an electronic document is created. After receiving an electronic document, the system and method identify the most appropriate character set encoding (or encodings) for the text of the electronic document. The character set encoding(s) indicate a list of potential languages in which the electronic document is created. The potential languages may be identified using bit flags. The number of potential languages for which an electronic document is created may be increased or decreased according to predetermined criteria. Frequently, however, a plurality of potential languages remain.

According to one embodiment of the invention, the system and method reduce the number of potential languages by comparing groups of characters (n-grams) included in the electronic document with entries in a look-up table. If n-grams are located in the look-up table, bit flags associated with the n-grams may be logically ANDed together. This process may be repeated until only a single bit flag remains. The remaining bit flag identifies the language in which the electronic document is created.

### BRIEF DESCRIPTION OF THE DRAWINGS

FIG. 1 illustrates a network architecture for evaluating the character sets of electronic messages according to the invention.

FIG. 2 is a flowchart illustrating character set processing according to a first embodiment of the invention.

FIG. 3 illustrates the bit masking action used for testing character set matches according to the invention.

FIG. 4 illustrates a multipart, multilanguage document for processing according to the invention.

FIG. 5 is a flowchart illustrating character set processing according to a second embodiment of the invention.

FIG. 6 is a flowchart illustrating character set processing according to a third embodiment of the invention.

FIG. 7 illustrates character set encoding according to the Unicode standard.

FIG. 8 is a flowchart illustrating document language determination according to one embodiment of the invention.

FIG. 9 illustrates a system for determining a language of a document according to one embodiment of the invention.

### DETAILED DESCRIPTION OF THE PREFERRED EMBODIMENT OF INVENTION

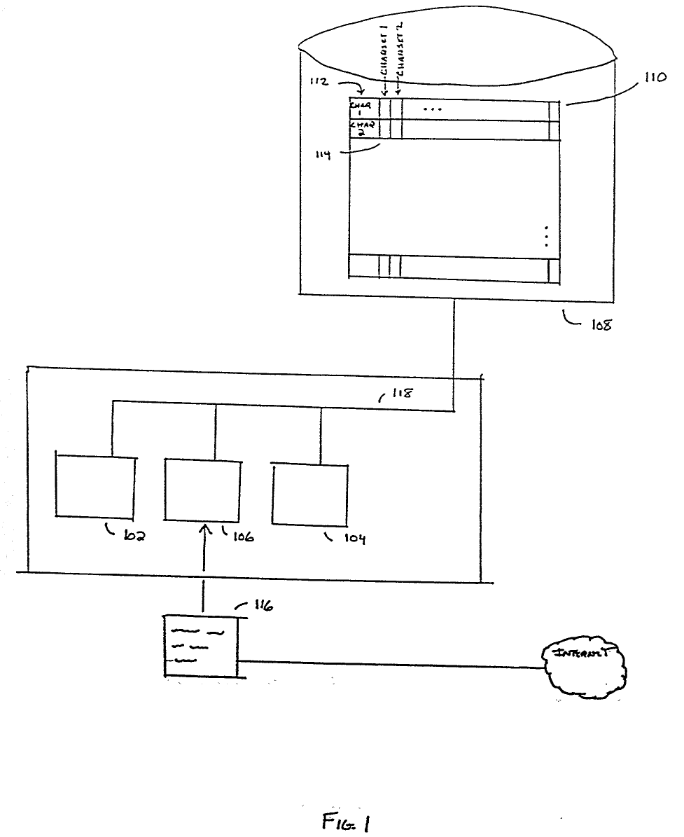

FIG. 1 illustrates a system for evaluating character sets according to the invention, in which a controller 102 is connected to an input/output unit 106, memory 104 (such as electronic random access memory) and storage 108 (such as a hard disk) over electronic bus 118, as will be appreciated by persons skilled in the art. Input/output unit 106 is configured to receive and transmit messages in electronic format, such as email or other textual forms. Controller 102 and associated components may be or include, for example, a computing device running the Microsoft Windows™ 95, 98, 2000, NT™, Unix, Linux, Solaris™, OS/2™, BeOS, MacOS™ or other operating system.

Input/output unit 106 may be connected to the Internet (as shown) or other network interfaces, using or including as a segment any one or more of, for instance, the Internet, an intranet, a LAN (Local Area Network), WAN (Wide Area Network) or MAN (Metropolitan Area Network), a frame relay connection, Advanced Intelligent Network (AIN) connection, a synchronous optical network (SONET) connection, digital T1, T3 or E1 line, Digital Data Service (DDS) connection, DSL (Digital Subscriber Line) connection, an Ethernet connection, ISDN (Integrated Services Digital Network) line, a dial-up port such as a V0.90, V0.34 or V0.34 bis analog modem connection, a cable modem, an ATM (Asynchronous Transfer Mode) connection, FDDI (Fiber Distributed Data Networks) or CDDI (Copper Distributed Data Interface) connections. Input/output unit 106 may likewise be connected to a network interface using or including WAP (Wireless Application Protocol), GPRS (General Packet Radio Service), GSM (Global System for Mobile Communication) or CDMA (Code Division Multiple Access) radio frequency links, RS-232 serial connections, IEEE-1394 (Firewire) connections, USB (Universal Serial Bus) connections or other wired or wireless, digital or analog interfaces or connections. Input/output unit 106 can also receive input data directly from a keyboard, scanner or any other data source. Input/output unit 106 receives an textual electronic message 116 in character-based, alphanumeric textual form for processing according to the invention. The necessary processing is initiated and carried out by controller 102, in cooperation with memory 104, input/output unit 106, storage 110 and related components, according to the following.

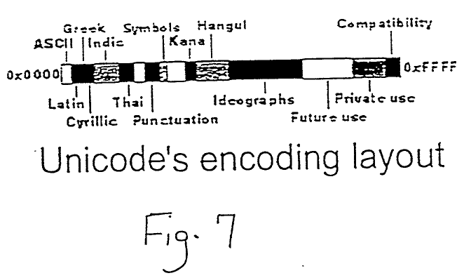

It should be noted that the invention presupposes that the characters of textual message 116 are available internally in a universal character set format. A universal character set refers to a character encoding scheme that can be used to encode a large number of alphabets. The invention supports at least two universal character sets, the internationally promulgated 16-bit Unicode, and LMBCS (Lotus Multi-Byte Character Set) but contemplates the use of any universal encoding scheme. An illustration of the 16-bit format of Unicode is shown in FIG. 7. As in shown that figure, the Unicode standard assigns different address ranges within the 16 bit address space to different scripts, so that when a character code point (address) is known, it is straightforward using the Unicode and coding layout to identify a corresponding script. The script in this sense is a larger lingual object than a character set, and can include symbols used within multiple languages.

Thus, the low level bit values for each character in the textual message 116 are expected by the invention to be presented in a predetermined binary format, even if the actual language being used to express the textual message 116 built from those characters is not clear or known ahead of time.

The system and method of the invention executes at least four decoding functions upon receipt of a textual message 116 of unknown language. The first is feasibility, that is, the decision at the threshold whether the textual message can be encoded in at least one of the character sets 114 recorded in a character table bank 110 stored in storage 108. If the textual message 116 can not be translated to any available character set, processing must be returned to the user without results.

The invention in a second regard generates a quantified list of the coverage offered by each of the character sets in the bank (and their associated languages) for every character of the textual message 116. Third, when no single character set perfectly expresses the textual message 116, the invention identifies the character set(s) that provides the best available coverage for the character string contained in textual message 116.

The invention fourthly provides a division mechanism which accepts textual messages containing different portions in different languages that therefore cannot be encoded entirely in one character set, and encodes them in multiple parts. This encoding option can be used for instance in multipart MIME messages.

All of these feature sets may be implemented using machine readable code compatible with controller 102 to generate application programming interfaces (APIs) and associated functions operating on character table bank 110. Character table bank 110 contains information about each character supported by the pool of character sets used by the invention, encoded in Unicode or other universal code.

The character table bank 110 in one embodiment includes all the alphanumeric alphabets used in the languages of Western, Central and Eastern Europe, North and South America, the Middle East, Republic of China, Peoples' Republic of China, Japan, Korea, Thailand, Vietnam and India. Character table bank 110 is extensible, and support for other languages can be added or others deleted. For those alphabets where multiple encodings are commonly in use, multiple entries can be created. For example, Western European character data can be encoded as ISO-8859-1 or Microsoft Windows™ codepage 1252. The particulars of those encoding standards are known in the art, including by way of standards published by the International Standards Organization.

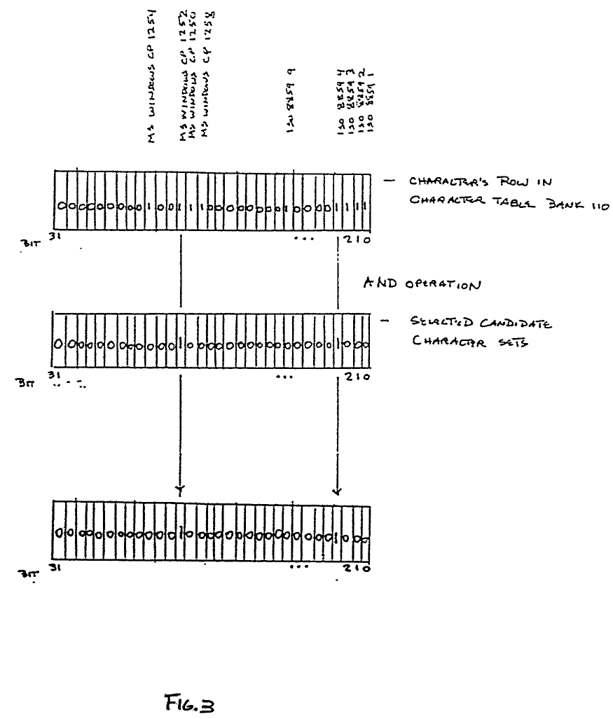

The format of character table bank 110, as illustrated for example in FIG. 3, is that each row represents an entry for one character contained in character field 112, the row being 32 bits wide. Across the row, each bit indicates whether the character contained in character field 112 for that row is contained in, and can be expressed by, a series of character sets. Each column of character table bank 110 represents one character set in predetermined sequence, and the bit value (Boolean true or false) in that column indicates whether the character set corresponding to that column can express the character which is the subject of that row.

In the first row of character table bank 110 illustrated in FIG. 1, the character is Á (Latin letter “A” with acute), and the first character field 112 represents ISO 8859-1 which is referred to as Latin-1, which is almost identical to MS Windows CP 1252 used in the Americas and Western Europe. (In other words, this encompasses English, Spanish, French, Portuguese, German, Dutch, Danish, Swedish, Norwegian, Italian, Finnish and some less widely used minority languages and variants such as Flemish, Catalan, Swiss German, etc.).

The second character field 112 represents ISO 8859-2, a.k.a. Latin-2, which is used to represent Central European languages: Polish, Czech, Slovak, Bulgarian, Slovenia, Croatian, Bosnian, Serbian, Macedonian and Romanian (some of these also have Cyrillic representations), and so forth. It will be noted that the character sets corresponding to each bit entry (column) in character field 112 need not strictly represent only the characters of a single language's alphabet, but can represent larger ensembles of several dialects or languages in an overall character set or script. For instance, the character set for the Korean language (ISO 2022-KR) contains Japanese characters, as a subset.

In the practice of the invention it is preferable that certain optimizations be performed on the character table bank 110. Those include encoding of the rows and columns of character table bank 110 for compression such as in hexadecimal format, for faster processing. Other encoding can be done for other desired properties such as faster processing or I/O (any of which can be done by appropriate conventional techniques).

ASCII data is also preferably excluded from character table bank 110, since all electronic document formats include this range as a subset. In other words, if the data can be encoded entirely in ASCII, they can be included in any and all other character set encodings. A further reason for excluding them is speed: a quick scan of the data can identify if the string can be encoded as ASCII without performing a look up against any tables. ASCII here refers to the set of characters described by the standard ISO 646 IRV. As noted, the illustrated embodiment is restricted to 32 bit wide rows, but this can be extended to 64 bits or other widths in different implementations.

Each character registered in the character field 112 of the character table bank 110 is encoded according to the character's Unicode code value. It is this value that is used to test an input letter or other character from electronic message 116 to identify matching character sets. For example, and as illustrated in FIG. 3, the character Á encoded in Unicode by value U+00C1 has an entry (logical 1) indicating that it is present in the following character sets, each set having a particular corresponding column:

TABLE 1

| Character Set | Bit Number |
|---|---|
| ISO-8859-1 | 0 |
| ISO-8859-2 | 1 |
| ISO-8859-3 | 2 |
| ISO-8859-4 | 3 |
| ISO-8859-9 | 8 |
| MS Windows CP 1258 | 17 |
| MS Windows CP 1250 | 18 |
| MS Windows CP 1252 | 19 |
| MS Windows CP 1254 | 22 |

As shown in FIG. 3, this results in a pattern of 32 bits of (little endian):

0000 0000 0100 1110 0000 0001 0000 1111

which is recorded as the entry across the first row of character table bank 110.

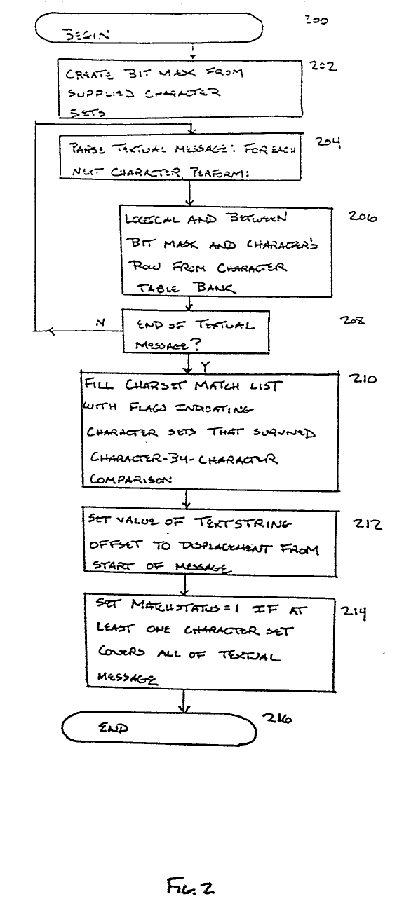

In one aspect of the invention illustrated in FIG. 2, upon receipt of an electronic message 116 the invention must determine at the threshold whether it is possible to express the characters making up the message in any of the available character sets stored in character table bank 110. The invention carries out this treatment according to the following processing steps, illustrated by the following generalized pseudocode (API):

TABLE 2
Funct EvaluateTextMessage: (TextString,TextStringLength,
CharSetTestList, CharSetMatchList, TextStringOffsetPosition,
MatchStatus)
The foregoing arguments or parameters in general relate to:
TextString: Contains the textual message to be tested.
TextStringLength: The length of the string, in bytes or characters,
or an indication that the textual message is NULL-terminated.
CharSetTestList: A list of character sets against which the textural
message is to be matched. The number of character sets in the list
is determined by a terminator mark.
CharSetMatchList: An empty list in which the number of matching
results are stored.
TextStringOffsetPosition: An offset initialized to zero where the
function returns the position in the string if the scan fails.
MatchStatus: a boolean value indicating whether all characters
were matched (logical 1, success) or less than all were matched
(logical 0, failure).

The function EvaluateTextMessage invokes the following processing steps, as illustrated in FIG. 2. It may be noted that the character sets against which the electronic textual message 116 will be tested need not include all available character sets in character table bank 110, but can be any selected group of character sets passed in the CharSetTestList parameter.

Processing begins in step 200. In step 202, a bit mask is created from the character sets supplied in the CharSetTestList parameter. This mask is in the same columnar format as the character table bank 110; that is, the desired candidate character sets have corresponding masks (logical value 1) in their assigned columns, as illustrated in FIG. 3.

In step 204, the parsing of textual message 116 is begun. For each character in the textual message, a logical AND is performed between the supplied character sets' bit mask and the value returned from the character's row of the character table bank 110. This process is repeated until the termination test of step 208 is met. That test is whether either the end of the textual message 116 has been reached, or the result of the mask is zero, indicating that the candidate character sets cannot represent any more of the textual message 116.

In step 210 the CharSetMatchList parameter is filled with logical values flagging the character sets that survived the character-by-character scan for the entire textual message 116. In step 212 the current position in the textual message 116 (displacement from the start of the message) is placed in the TextStringOffset parameter to return. Finally, in step 214 the MatchStatus parameter is set to return and indicate success (the entire textual message could be encoded) or failure (less than all of the textual message could be encoded). In step 216 processing ends.

The returned list of matching character sets in CharSetMatchList is in the same order in which they were specified to the function EvaluateTextMessage, retaining their implicit priority. Controller 102 may then operate to present the list of matching character sets to a user for selection, if desired. As a preferable option, if the string contains only characters that can be encoded in ASCII, this character set is returned as the first in the list, even if it was not explicitly included in the input list. ASCII is returned for similar reasons as noted above: if the data are all ASCII, any encoding can be used. (In the Lotus Notes™ environment discussed below this is an indication that the standard MIME designation of US-ASCII is to be used).

Note that the TextStringOffset parameter must be initialized to zero. This means that the function EvaluateTextMessage can be called several times with the offset parameter automatically being advanced. This has the desirable effect in one embodiment of splitting a multilingual document into multiple MIME text parts.

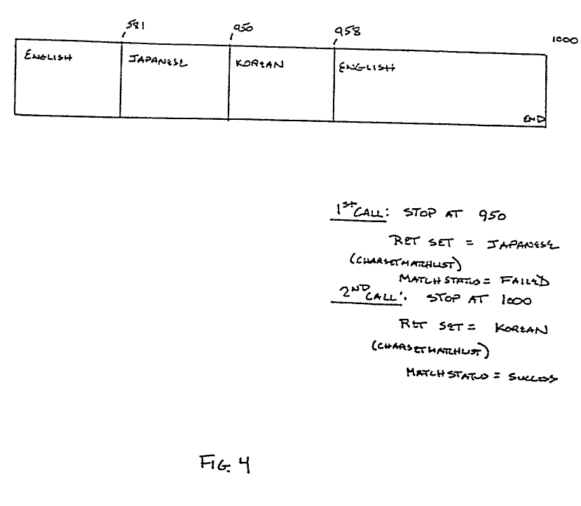

For example, as illustrated in FIG. 4 assume we have a multilingual document containing the following textual segments:

| Position | Character Set (Language) |
|---|---|
| offset 0 | English |
| offset 581 | Japanese |
| offset 950 | Korean |
| offset 958 | English |
| offset 1000 | (end) |

Assume that parameter CharSetTestList contains the entries ISO-2022-JP, ISO-2022-KR and US-ASCII. (Under the ISO standards, since all character sets support ASCII, this implies that the Japanese and Korean character sets also support English). Then the first call for the function EvaluateTextMessage (with TextStringOffset=0) stops at offset 950, with the CharSetMatchList set equal to ISO-2022-JP, and the MatchStatus return value as failed. This is because no given character set can represent all of the characters of English, Japanese and Korean at the same time.

Calling the function again without resetting the TextStringOffset and with the same input character set test list results in the CharSetMatchList being returned as ISO-2022-KR for the next segment of textual message 116, since Korean is a superset of Japanese. The offset at this juncture is 1000 (the end) and the MatchStatus flag is set to success. In cases where the MatchStatus flag returns a failure, the calling resource can default to choose Unicode as the encoding method for the textual message 116.

In another embodiment of the invention, it may be desirable to develop more detailed quantitative information concerning the degree of overlap of different character sets to the characters of the textual message 116. A corresponding API is presented in the following table, which differs from the functionality above in Table 2 in that it returns the number of characters that can be encoded in each of the partially matching character sets.

TABLE 3
Funct EvaluateTextMessageWithCount: (TextString,
TextStringLength, CharSetTestList, CharSetCountList,
TextStringOffsetPosition, FullMatch)
The foregoing arguments in general relate to:
TextString: Contains the textual message to be tested.
TextStringLength: The length of the string, in bytes or characters,
or an indication that the textual message is NULL-terminated.
CharSetTestList: A list of character sets against which the textural
message is to be matched. The number of character sets in the list is
determined by a terminator mark.
CharSetCountList: An empty list in which the accumulated match
results are stored, one-to-one with the supplied list of test character sets.
TextStringOffsetPosition: An offset initialized to zero where the
function returns the position in the string if the scan fails.
FullMatch: a boolean value indicating whether all characters were
matched or less than all were matched.

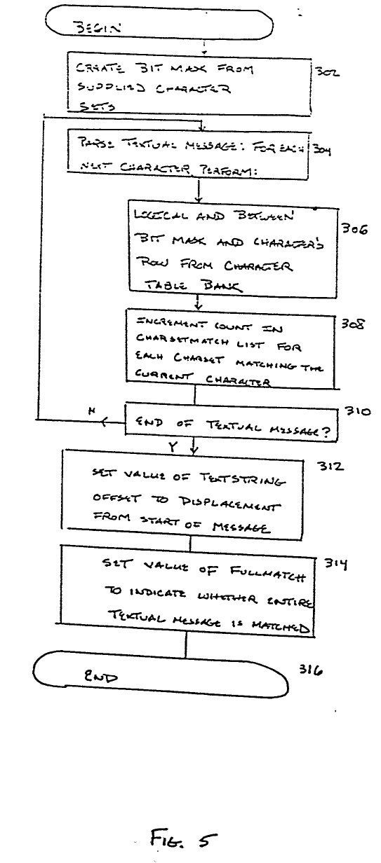

The function EvaluateTextMessageWithCount invokes the following processing steps, illustrated in FIG. 5. Processing begins in step 300. In step 302, a bit mask is created from the character sets supplied in the parameter CharSetTestList. Again, this mask has the same correspondence between columns and character sets as the character table bank 110. In step 304, parsing of the textual message 116 is begun. For each character, in step 306 a logical AND is performed between the bit masks of CharSetTestList and the value returned from the character's row of character table bank 110, in the manner illustrated in FIG. 3.

In step 308, the results of the logical AND operation are stored by incrementing a corresponding count parameter in CharSetMatchList for each matching character set. These steps are repeated until the end of message test (as above) of step 310 is reached. In step 312, the current position in the textual message string (displacement from the start) is stored in the TextStringOffsetPosition parameter. In step 314, the FullMatch parameter is returned, indicating either a full match of the supplied textual message 116 to one or more character sets (logical 1), or not (logical 0, less than all of the message string could be encoded). After the entire textual message 116 is parsed, the count parameter for each character set in CharSetMatch list reflects the total number of matches that set contains for that message. In step 316, processing ends.

In another embodiment of the invention, the invention makes a normative decision concerning the character set which best matches the characters of the textual message 116. A corresponding API is presented in the following Table 4, which differs from the functionality above in Tables 2 and 3 in that it returns the number of characters that can be encoded in each of the partially matching character sets. The invention then automatically chooses the character set that best represents the given textual message 116. One purpose of this embodiment is to provide a utility whereby multilingual data can be sent with least possible information loss, when circumstances prevent the use of a universal character set or a multi-part mail message.

TABLE 4
Funct EvaluateTextMessageWithBestMatch: (TextString,
TextStringLength, CharSetTestList, CharSetMatchList,
CharSetWeightList,
BestMatchCharSet, TextStringOffsetPosition, MatchStatus)
The foregoing arguments in general relate to:
TextString: Contains the textual message to be tested
TextStringLength: The length of the string, in bytes or characters,
or an indication that the textual message is NULL-terminated.
CharSetTestList: A list of character sets against which the textural
message is to be matched. The number of character sets in the list is
determined by a terminator mark.
CharSetMatchList: An empty list in which the matching results are
stored.
CharSetWeightList: A list of relative weights to be assigned to
different character sets when performing evaluation.
BestMatchCharSet: An indicator of which of the CharSetTestList
provides the best weighted fit to the supplied textual message.
TextStringOffsetPosition: An offset initialized to zero where the
function returns the position in the string if the scan fails.
MatchStatus: a boolean value indicating whether all characters
were matched (logical 1, success) or less than all were matched
(logical 0, failure).

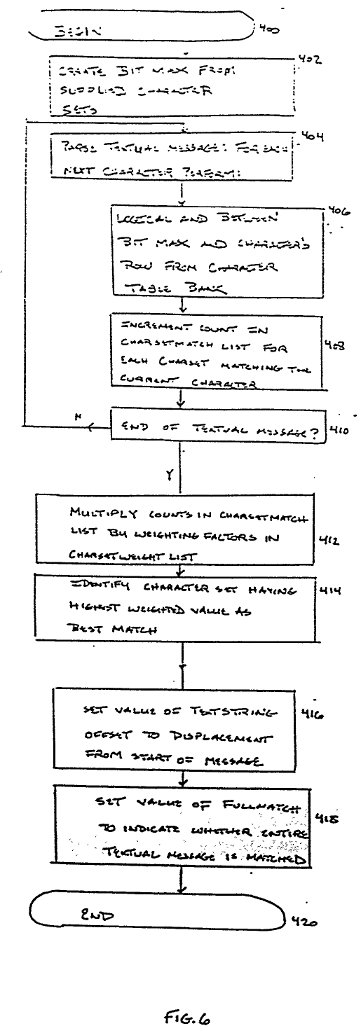

The function invokes the following processing steps, illustrated in FIG. 6. Processing begins in step 400. In step 402, as above a bit mask is created from the character sets supplied in the parameter CharSetTestList. Again, this mask has the same correspondence between columns and character sets as the character table bank 110. In step 404, the parsing of textual message 116 is begun. For each character, in step 406 a logical AND is performed between the bit masks of CharSetTestList and the value returned from the character's row of character table bank 110. In step 408, the results of the logical AND operation are stored by incrementing a corresponding count for each matching character set in CharSetMatchList. These steps are repeated until the end of the textual message 116 has been reached at the end of message test (as above) of step 410.

In step 412, the totals in the CharSetMatch list are multiplied by the corresponding weights contained in the CharSetWeightList, to generate a weighted match total. The CharSetWeightList takes into account Han unification, in which the ideographic characters used in China, Taiwan, Japan and Korea are mapped to the same codepoint in Unicode, even though these may have slightly different visual representations in each of the countries. In other words, the visual variants have been unified to a specific single binary representation for these languages.

In step 414, the character set having the highest total after these calculations is identified and stored in the parameter BestMatchCharSet as the best match to the textual message 116. In step 416, the current position in the textual message string (displacement from the start) is stored in the TextStringOffsetPosition parameter. In step 418, the FullMatch parameter is returned, indicating either a full match of the supplied textual message 116 to one or more character sets (logical 1), or not (logical 0, less than all of the message string could be encoded). In step 420, processing ends.

The invention in one implementation finds application in the Lotus Notes™/Domino™ environment, for a variety of textual functions. In one respect, the Notes™ client application stores/processes messages in a multilingual character set (Unicode or LMBCS). When these are sent to the Internet, this internal character set must be converted to the appropriate character set for use on the Internet. The logic executed by the invention as described herein can tell the Notes™ client which character set should be used, based on the content of the message.

Sometimes Notes™ receives Unicode messages arrive directly from the Internet. Notes™ converts these messages into an internal character set, but must know which language is used in the message. Applying the logic of this invention, if the message can be well represented in a Korean character set, a client application can assume that it is a Korean message. This allows Notes™ for instance to accurately encode the message in its internal Korean character set.

Notes™ and other client applications can also enhance full text search features using the logic of the invention in at least two ways. First, the invention in this regard can be used to create a search index. The search engine in Lotus Notes™ depends on an associated codepage representing each document that is to be indexed. The invention can indicate the most appropriate character set to or sets assign to a codepage to use for this indexing, based on the character set that can best represent it.

Second, in terms of executing searches the Notes™ search engine stores index information into several indices for each codepage. When a query is executed, the query string is processed according to the invention to determine the character set that should be used, thereby dictating which index (or indices) to search. For example, if the query string is in English, all indices are searched. (Again, the reason for assuming that English is in all indices is because ASCII, which can be used to encode all English, is a subset of all the character sets currently supported). However, if the query string is in Greek, the search may be restricted to the Greek index for only documents containing that character set. These commercial embodiments and client implementations are exemplary, and many others are contemplated through the character set evaluation technology of the invention.

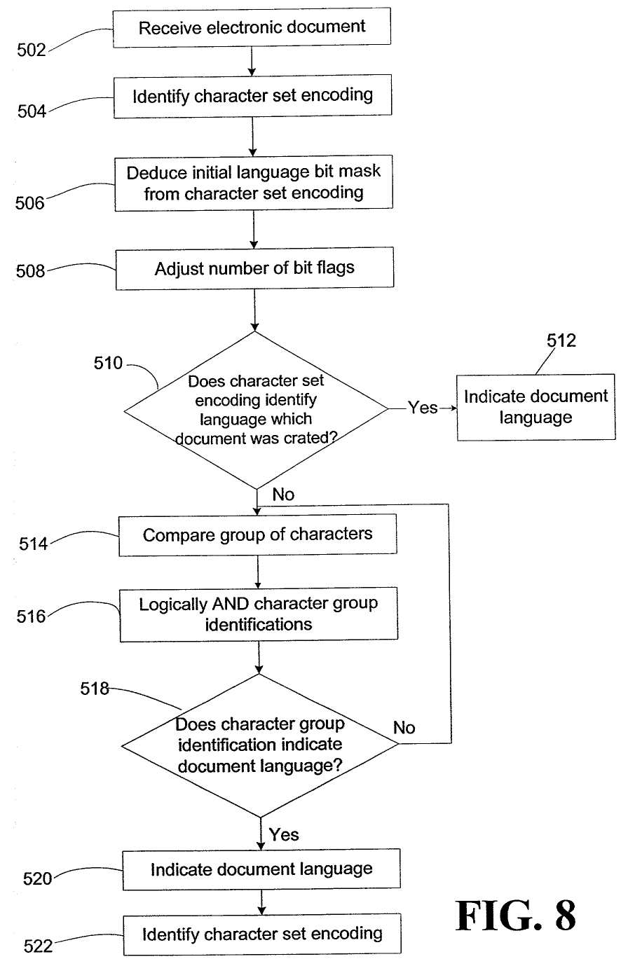

FIG. 8 is a flowchart indicating a method of determining a language in which an electronic document is created according to one embodiment of the invention. An electronic document is received in step 502. An appropriate character set encoding or encodings for the electronic document are identified in step 504. The method for determining an appropriate character set encoding(s) may be the method described above. The character set encoding(s) identified indicate a list of potential languages in which the electronic document is created. The potential languages may be indicated using language bit flags, as deduced from the groups of characters (n-grams) in step 506. The language bit flags may be used to identify the potential languages in which the electronic document is created. The language bit flags may function according to the process described above and shown in FIG. 3. The number of bit flags may be increased or decreased according to predetermined criteria in step 508. The predetermined criteria may be, for example, eliminating a potential language if the electronic document is from a particular source. Other criteria may also be used.

A determination may be made regarding whether the character set encoding(s) identifies the language in which the electronic document is created. If a single language bit flag remains after applying the predetermined criteria, the remaining language bit flag is used to identify the language in which the document is created in step 512.

If, however, multiple bit flags remain, n-grams included in the electronic document may be compared to entries in, for example, a look-up table in step 514. If the n-grams are located in the look-up table, the bit flags detected in step 506 may be logically ANDed together in step 516 to reduce the number of potential languages in which the electronic document is created. A determination may then be made in step 518 to determine whether the bit flag remaining indicates a document language in which the electronic document is created. If the language bit flags do not indicate the document language, the remaining language bit flags may be logically ANDed together in step 516 until a single bit flag remains.

After a determination is made in step 518 that the bit flag indicates the document language, the document language may be indicated in step 520. This may be achieved by assigning a bit flag to the electronic document that indicates the document language. The document language indication may then be used to refine the character set encoding identification for the electronic document.

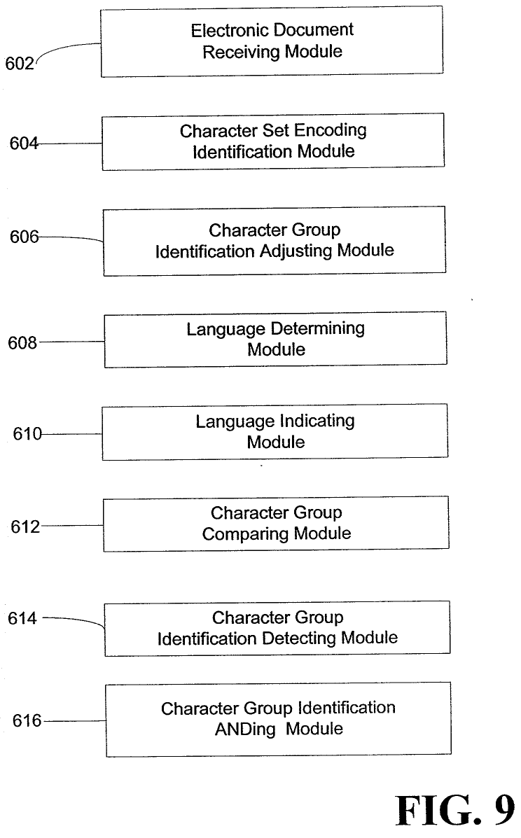

FIG. 9 illustrates a system for determining a language in which an electronic document is created. The system may include electronic document receiving module 602, character set encoding identification module 604, character group identification adjusting module 606, language determining module 608, language indicating module 610, character group comparing module 612, character group identification detecting module 614, and character group identification ANDing module 616. An electronic document, for example, an electronic mail message, may be received using electronic document receiving module 602. Electronic document receiving module 602 (and the other modules listed above) may all or partly reside on, for example, a network server. Therefore, an electronic mail message may be received after a user sends the electronic mail message.

Character set encoding module 604 may then determine the character set encoding(s) for the electronic document. The character set encoding(s) determined may be used to indicate a list of potential languages in which the electronic document is created. Bit flags associated with the potential languages may be adjusted using character group identification adjusting module 606 to increase or decrease a number of potential languages in which the electronic document is created. Language determining module 608 may be used to determine whether the bit flag identifies the language in which the electronic document is created. For example, if character group identification adjusting module 606 reduces the number of bit flags to a single bit flag, that single bit flag identifies the language in which the electronic document is created. Language indicating module 610 may then be used to indicate the language in which the electronic document is created. If, however, a plurality of bit flags remain, character group comparing module 612 may compare n-grams included in the electronic document with entries in, for example, a look-up table. If the n-grams are located in the look-up table, character group identification detecting module 614 may be used to detect bit flags associated with the n-grams. The bit flags associated with the n-grams located may be logically ANDed together to reduce a number of potential languages in which the electronic document is created. This may be repeated until a single bit flag remains. When a single bit flag remains, the language identified by the bit flag may be indicated using, for example, language indicating module 610.

The invention also contemplates the preparation and storage of computer software in a machine-readable format such as a floppy or other magnetic, optical or other drive, which upon execution carries out the character set evaluation actions of the invention.

The foregoing description of the system and method of the invention is illustrative, and variations in implementation and configuration will occur to persons skilled in the art. For instance, while the invention has been described as decoding a received textual email message, many other varieties of messages, including alphanumeric pages, wireless telephony, teletype and others may be evaluated according to the principles of the invention. Character set processing according to the invention moreover can be carried out locally in a client workstation, remotely on a server or in other manners and on other suitable hardware. The scope of the invention is accordingly intended to be limited only by the following claims.

What is claimed is:

1. A method for determining a language in which a document is created comprising the steps of:
a) receiving at least one electronic document;
b) identifying at least one character set encoding used in the at least one electronic document;
c) determining whether the at least one character set encoding identifies a language in which the electronic document is created; and
d) indicating the language in which the electronic document is created if a determination is made that the at least one character set encoding identifies the language in which the electronic document is created.

2. The method of claim 1, wherein the step of c) determining determines that the at least one character set encoding identifies at least two potential languages in which the electronic document is created.

3. The method of claim 2, further comprising the step of e) comparing at least one group of characters in the electronic document to predetermined groups of characters.

4. The method of claim 3, further comprising the step of f) detecting at least one identification for the at least one group of characters.

5. The method of claim 3, wherein the at least one group of characters is an n-gram.

6. The method of claim 4, wherein the at least one identification is a bit-flag.

7. The method of claim 4, further comprising the step of g) logically ANDing the at least one identification.

8. The method of claim 7, wherein the step of g) logically ANDing the at least one identification is repeated until a single identification is determined.

9. The method of claim 8, further comprising the step of h) indicating the language in which the electronic document is created.

10. The method of claim 9, further comprising the step of i) identifying a character set encoding for the language indicated.

11. A system for determining a language in which a document is created comprising:
receiving means for receiving at least one electronic document;
identifying means for identifying at least one character set encoding used in the at least one electronic document;
determining means for determining whether the at least one character set encoding identifies a language in which the electronic document is created; and
indicating means for indicating the language in which the electronic document is created if a determination is made that the at least one character set encoding identifies the language in which the electronic document is created.

12. The system of claim 11, wherein the determining means determines whether the at least one character set encoding identifies at least two potential languages in which the electronic document is created.

13. The system of claim 12, further comprising comparing means for comparing at least one group of characters in the electronic document to predetermined groups of characters.

14. The system of claim 13, further comprising detecting means for detecting at least one identification for the at least one group of characters.

15. The system of claim 13, wherein the at least one group of characters is an n-gram.

16. The system of claim 14, wherein the at least one identification is a bit-flag.

17. The system of claim 14, further comprising logical ANDing means for logically ANDing the at least one identification.

18. The system of claim 17, wherein the logically ANDing means logically ANDs the at least one identification until a single identification is determined.

19. The system of claim 18, further comprising language indicating means for indicating the language in which the electronic document is created.

20. The system of claim 19, further comprising character set encoding identifying means for identifying a character set encoding for the language indicated.

21. A system for determining a language in which a document is created comprising:
a receiving module that receives at least one electronic document;
an identifying module that identifies at least one character set encoding used in the at least one electronic document;
a determining module that determines whether the at least one character set encoding identifies a language in which the electronic document is created; and
an indicating module that indicates the language in which the electronic document is created if a determination is made that the at least one character set encoding identifies the language in which the electronic document is created.

22. The system of claim 21, wherein the determining module determines whether the at least one character set encoding identifies at least two potential languages in which the electronic document is created.

23. The system of claim 22, further comprising a comparing module that compares at least one group of characters in the electronic document to predetermined groups of characters.

24. The system of claim 23, further comprising a detecting module that detects at least one identification for the at least one group of characters.

25. The system of claim 23, wherein the at least one group of characters is an n-gram.

26. The system of claim 24, wherein the at least one identification is a bit-flag.

27. The system of claim 24, further comprising a logical ANDing module that logically ANDs the at least one identification.

28. The system of claim 27, wherein the logically ANDing module logically ANDs the at least one identification until a single identification is determined.

29. The system of claim 28, further comprising a language indicating module that indicates the language in which the electronic document is created.

30. The system of claim 29, further comprising a character set encoding identifying module that identifies a character set encoding for the language indicated.

31. A processor readable medium comprising processor readable code that causes a processor to determine a language in which a document is created, the processor readable medium comprising:
receiving code that causes a processor to receive at least one electronic document;
identifying code that causes a processor to identify at least one character set encoding used in the at least one electronic document;
determining code that causes a processor to determine whether the at least one character set encoding identifies a language in which the electronic document is created; and
indicating code that causes a processor to indicate the language in which the electronic document is created if a determination is made that the at least one character set encoding identifies the language in which the electronic document is created.

32. The medium of claim 31, wherein the determining code determines whether the at least one character set encoding identifies at least two potential languages in which the electronic document is created.

33. The medium of claim 32, further comprising comparing code that causes a processor to compare at least one group of characters in the electronic document to predetermined groups of characters.

34. The medium of claim 33, further comprising detecting code that causes a processor to detect at least one identification for the at least one group of characters.

35. The medium of claim 33, wherein the at least one group of characters is an n-gram.

36. The medium of claim 34, wherein the at least one identification is a bit-flag.

37. The medium of claim 34, further comprising logical ANDing code that causes a processor to logically AND the at least one identification.

38. The medium of claim 37, wherein the logically ANDing code logically ANDs the at least one identification until a single identification is determined.

39. The medium of claim 38, further comprising language indicating code that causes a processor to indicate the language in which the electronic document is created.

40. The medium of claim 39, further comprising character set encoding identifying code that causes a processor to identify a character set encoding for the language indicated.
